(19) United States
(12) Patent Application Publication
(10) Pub. No.: US 2025/0232163 A1
(43) Pub. Date: Jul. 17, 2025

(54) MEMORY CIRCUITS WITH MULTI-ROW STORAGE CELLS AND METHODS FOR OPERATING THE SAME

(71) Applicant: Taiwan Semiconductor Manufacturing Company, Ltd., Hsinchu (TW)

(72) Inventors: Xiaoyu Sun, Hsinchu City (TW); Brian Crafton, Hsinchu City (TW); Murat Kerem Akarvardar, Hsinchu City (TW)

(73) Assignee: Taiwan Semiconductor Manufacturing Company, Ltd., Hsinchu (TW)

(21) Appl. No.: 18/757,043

(22) Filed: Jun. 27, 2024

Related U.S. Application Data
(60) Provisional application No. 63/621,248, filed on Jan. 16, 2024.

(51) Int. Cl. G06N 3/063; G06F 12/0875

(52) U.S. Cl. CPC G06N 3/063; G06F 12/0875

(57) ABSTRACT

A memory circuit includes a first buffer configured to store a plurality of first data elements; a second buffer configured to store a plurality of second data elements; a controller configured to generate a control signal based on a layer type; an array comprising a plurality of processing elements (PEs), each of the PEs including a plurality of storage cells; and a data router configured to receive the control signal and determine whether to store, in the storage cells of each of the PEs, a corresponding one of the plurality of first data elements or corresponding ones of the plurality of second data elements based on the control signal.

### CROSS-REFERENCE TO RELATED APPLICATION

This application claims priority to and the benefit of U.S. Provisional Application No. 63/621,248, filed Jan. 16, 2024, entitled “METHOD TO IMPROVE EFFICIENCY OF MULTI-STORAGE-ROW COMPUTATION-IN-MEMORY,” which is incorporated herein by reference in its entirety for all purposes.

### BACKGROUND

Artificial intelligence (AI), or machine learning (ML), is a powerful tool that can be used to simulate human intelligence in machines that are programmed to think and act like humans. AI can be used in a variety of applications and industries. AI accelerators are hardware devices that are used for efficient processing of AI workloads like neural networks. One type of AI accelerator includes a systolic array that can perform operations on inputs via multiplication and accumulate operations.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an example neural network, in accordance with some embodiments.

FIG. 2 illustrates an example block diagram of an input (A) processed in a convolution mechanism with a weight (W), in accordance with some embodiments.

FIG. 3 illustrates a schematic diagram of an example convolution between at least a portion of the input A and the weight W of FIG. 2, in accordance with some embodiments.

FIG. 4 illustrates an example schematic diagram of an input (X) processed in an attention mechanism, in accordance with some embodiments.

FIG. 5 illustrates an example block diagram of a Compute-In-Memory (CIM) circuit, in accordance with some embodiments.

FIG. 6 illustrates an example circuit diagram of a data router of the CIM circuit of FIG. 5, in accordance with some embodiments.

FIG. 7 illustrates another example block diagram of an input (A) processed in a convolution mechanism with a weight (W), in accordance with some embodiments.

FIG. 8 illustrates a schematic diagram of how data elements are stored in processing elements of the CIM circuit of FIG. 5 when the layer type is indicated as a regular convolutional layer (or attention layer), in accordance with some embodiments.

FIG. 9 illustrates a schematic diagram of how data elements are stored in processing elements of the CIM circuit of FIG. 5 when the layer type is indicated as a depth-wise convolutional layer, in accordance with some embodiments.

FIG. 10 illustrates an example circuit diagram of a column-wise write circuit of the CIM circuit of FIG. 5, in accordance with some embodiments.

FIG. 11 illustrates an example block diagram of a portion of an attention mechanism, in accordance with some embodiments.

FIG. 12 is an operation flow illustrating how the column-wise write circuit of FIG. 10 processes the input tensor X, key weight matrix W_{K}, and query matrix Q of FIG. 11, in accordance with some embodiments.

FIG. 13 illustrates an example flow chart of a method for operating the CIM circuit of FIG. 5, in accordance with some embodiments.

FIG. 14 illustrates an example flow chart of another method for operating the CIM circuit of FIG. 5, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

An AI accelerator is a class of specialized hardware to accelerate machine learning workloads for deep neural network (DNN) processing, which are typically neural networks that involve massive memory accesses and highly-parallel but simple computations. AI accelerators can be based on application-specific integrated circuits (ASIC) which include multiple processing elements (PEs) (or processing circuits) arranged spatially or temporally to perform a part of the multiply-and-accumulate (MAC) operation. The MAC operation is performed based on input activation states (sometimes referred to as input data elements) and weights (sometimes referred to as weight data elements), and then summed together to provide output activation states. The input activation states and the output activation states are typically referred to as an input and output of the PEs, respectively.

Typical AI accelerators (called fixed dataflow accelerator (FDAs)) are customized to support one fixed dataflow such as an output stationary dataflow, an input stationary dataflow, or a weight stationary dataflow. However, AI workloads include a variety of layer types/shapes that may favor different dataflows, e.g., one dataflow that fits one workload, or one layer may not be the optimal solution for the others, thus limiting the performance. For example, various layer types may include regular convolutional layers, depth-wise convolutional layers, attention layers, fully connected layers, etc. In a typical dataflow architecture, one or more convolutional layers may be followed by a fully connected layer that outputs (or flattens) the previous outputs into a single vector. However, the convolutional layer type is typically more efficient for certain dataflows and the fully connected layer type is typically more efficient for different dataflows. Given the diversity of the workloads in terms of layer type, one dataflow that fits one workload or one layer may not be the optimal solution for the others thus limiting the performance.

The present disclosure provides various embodiments of an AI accelerator implemented as a memory circuit that can adaptively process a variety of layer types. Based on identifying the layer type of a corresponding neural network, the memory circuit can adjust configurations or operations of its components to optimize usage efficiency of the components. For example, the memory circuit can include a memory array with a plural number of processing elements, and each of the processing elements can include a plural number of storage cells. The memory circuit can include a data router to cause the storage cells of each processing element to selectively store at least a singular one of a plurality of weight data elements or store plural ones of a plurality of input data elements, based on a layer type (e.g., a regular convolutional layer, an attention layer, or a depth-wise convolutional layer) for processing the weight data elements and the input data elements. With such a flexibility, the multiple storage cells of each processing element can be utilized with improved efficiency, which in turn enhances overall energy-efficiency and throughput of the disclosed AI accelerator. Further, the memory circuit can include a column-wise write circuit that can simultaneously read out intermediate results from the processing elements row-by-row (or row-wise) and write back those intermediate results into the processing elements column-by-column (or column-wise). As such, the memory circuit is free from having additional buffer and read/write operations to transpose a matrix, which generally makes processing an attention layer of a neural network significantly challenging. Though the disclosed column-wise write circuit, the disclosed memory circuit can even process an attention layer (in addition to the regular convolutional layer and depth-wise convolutional layer) with low energy, low latency, and small area.

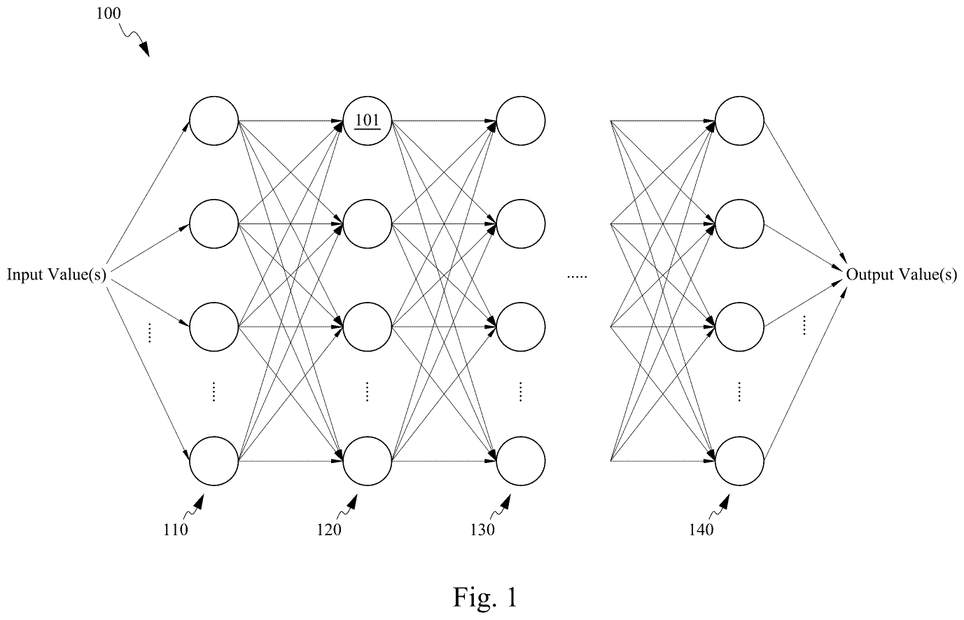

FIG. 1 illustrates an example neural network 100, in accordance with various embodiments. As shown, the neural network 100 includes four layers 110, 120, 130, and 140, where the layers 110 and 140 are referred to as an input layer and output layer, respectively, and the layers 120 to 130 are each referred to as a hidden layer. Each of the layers can include a number of neurons. In general, the hidden layers of the neural network 100 can largely be viewed as layers of neurons that each receive weighted outputs from the neurons of other (e.g., preceding) layer(s) of neurons in a mesh-like interconnection structure between layers. The weight of connection from the output of a particular preceding neuron to the input of another subsequent neuron is set according to the influence or effect that the preceding neuron is to have on the subsequent neuron (for simplicity, only one neuron 101 and the weights of input connections are labeled). Herein, the output value of the preceding neuron is multiplied by the weight of its connection to the subsequent neuron to determine the particular stimulus that the preceding neuron presents to the subsequent neuron.

A neuron's total input stimulus corresponds to the combined stimulation of all of its weighted input connections. According to various implementations, if a neuron's total input stimulus exceeds some threshold, the neuron is triggered to perform some, e.g., linear or non-linear mathematical function on its input stimulus. The output of the mathematical function corresponds to the output of the neuron which is subsequently multiplied by the respective weights of the neuron's output connections to its following neurons. Generally, the more connections between neurons, the more neurons per layer and/or the more layers of neurons, the greater the intelligence the network is capable of achieving. As such, neural networks for actual, real-world artificial intelligence applications are characterized by large numbers of neurons and large numbers of connections between neurons. Extremely large numbers of calculations (not only for neuron output functions but also weighted connections) are therefore involved in processing information through a neural network.

The processing that is performed on the input stimulus is based on a layer type (or mechanism). A neural network can have or implement a variety of layer types (or mechanisms) such as for example, a fully connected layer, a convolutional layer, a deconvolutional layer, a recurrent layer, an attention layer, etc. In general, a convolutional layer (or convolutional mechanism) is the core building block of a convolutional neural network. The parameters of a convolutional layer consist of a set of learnable filters (sometimes referred to as kernels or weights), where each filter has a width and a height which are often in a square. These filters are small (in terms of their spatial dimensions) but extend throughout the full depth of the volume. Based on the configuration of a convolutional layer, there may be further convolutions: a regular convolution (sometimes referred to as a regular convolutional layer) and a depth-wise convolution (sometimes referred to as a depth-wise convolutional layer). The key difference between the regular convolutional layer and the depth-wise convolutional layer is that the depth-wise convolution applies the convolution along only one spatial dimension (sometime referred to as a channel) while the regular convolution is applied across all spatial dimensions/channels at each step. The concept of an attention layer (or attention mechanism) is to improve recurrent neural networks (RNNs) for handling longer sequences or sentences. The attention mechanism enhances the information content of an input stimulus embedding by including information about the input's context. In other words, the attention mechanism enables the model to weigh the importance of different elements in an input stimulus and dynamically adjust their influence on the output.

In general, a neural network computes weights to perform computation on input data (input stimulus or input). Machine learning currently relies on the computation of dot-products and absolute difference of vectors, typically computed with multiply-accumulate (MAC) operations performed on the parameters, input data and weights. The computation of large and deep neural networks typically involves so many data elements, and thus it is not practical to store them in processor cache. Accordingly, these data elements are usually stored in a memory. Thus, machine learning is very computationally intensive with the computation and comparison of many different data elements. The computation of operations within a processor is orders of magnitude faster than the transfer of data elements between the processor and main memory resources. Placing all the data elements closer to the processor in caches is prohibitively expensive for the great majority of practical systems due to the memory sizes needed to store the data elements. Thus, the transfer of data elements becomes a major bottleneck for AI computations. As the data sets increase, the time and power/energy a computing system uses for moving data elements around can end up being multiples of the time and power used to actually perform computations.

In this regard, a Compute-In-Memory (CIM) circuit has been proposed to perform such MAC operations. A CIM circuit instead conducts data processing in situ within a suitable memory circuit. The CIM circuit suppresses the latency for data/program fetch and output results upload in corresponding memory (e.g. a memory array), thus solving the memory (or von Neumann) bottleneck of conventional computers. Another key advantage of the CIM circuit is the high computing parallelism, thanks to the specific architecture of the memory array, where computation can take place along several current paths at the same time. The CIM circuit also benefits from the high density of multiple memory arrays with computational devices, which generally feature excellent scalability and the capability of 3D integration. As a non-limiting example, the CIM circuit targeted for various machine learning applications can perform the MAC operations locally within the memory (i.e., without having to send data elements to a host processor) to enable higher throughput dot-product of neuron activation and weight matrices, while still providing higher performance and lower energy compared to computation by the host processor.

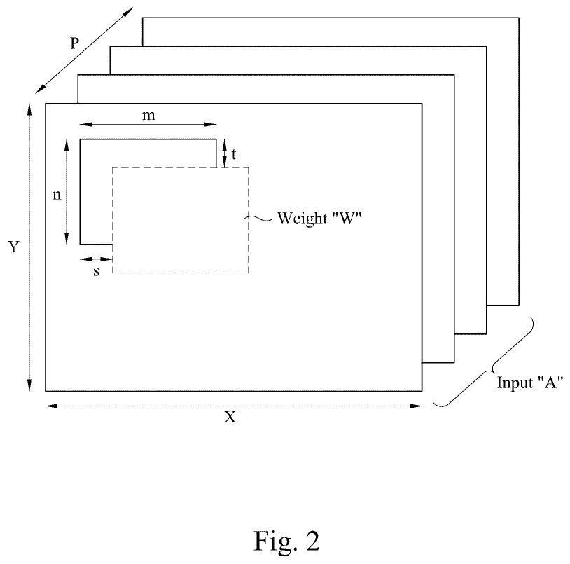

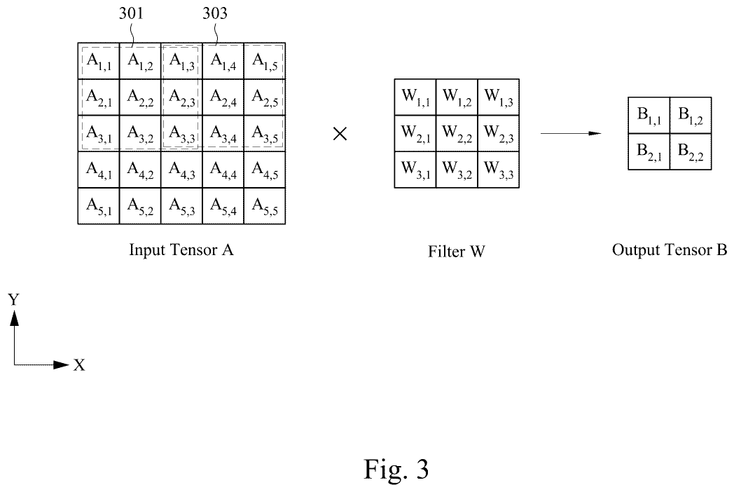

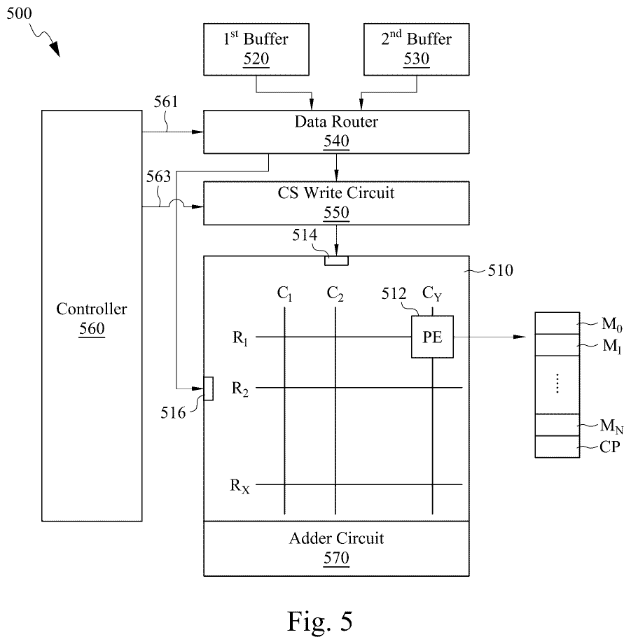

FIG. 2 illustrates an example block diagram of an input “A” processed in a convolution mechanism with a weight “W,” and FIG. 3 illustrates a schematic diagram of an example convolution between at least a portion of the input A and the weight W of FIG. 2, in accordance with various embodiments. It should be noted that the schematic diagram of FIG. 3 is provided merely as a non-limiting example for illustrative purposes, and does not intend to limit the scope of the present disclosure. For example, the disclosed memory circuit (e.g., FIG. 5) can also be implemented to process any of various other convolutional layer types, while within the scope of the present disclosure.

As shown in FIG. 2, the input (A) to a regular convolution layer is typically arranged as an input tensor A having “P” planes of input data elements (which may sometimes be referred to as neurons or activations). Each plane has a dimension X×Y of input data elements, which is generally referred to as an input channel or channel. A regular convolution layer is associated with one or more trainable weights, filters, or kernels (W's). Each filter W includes a plurality of weight data elements. For example, with a regular convolution layer, each filter W has a dimension of m×n×P. As such, the filter W is shared across the multiple planes (channels) of the input tensor A. Stated another way, the filter W is as deep as the input tensor, allowing the channels to be freely mixed for generating the output. In another example, with a depth-wise convolution layer, the channels of the input tensor A are separate and are each convolved with a respective filter W. As such, multiple filters W with respectively different dimensions (e.g., m×n×1) are commonly leveraged.

To produce an output (e.g., through multiplying the input tensor A by the one or more filters W's), each filter W is convolved with the input tensor A by sliding the filter W across the input tensor A in the X and Y directions at steps “s” and “t,” respectively. A size of the sliding step in a certain direction is generally referred to as a stride size in that direction. At each step, a dot product of the input data element and the weight data element is calculated to produce an output data element (which may be referred to as an output neuron). The input data elements applied to the weight data elements at any step are generally referred to as a convolution window (or window) of the input tenor A. Each filter W thus produces an output plane or output tensor “B” (e.g. a two-dimensional set of output data elements or output neurons, which may be referred to as an activation map or an output channel) of the output.

Generally, a convolution operation produces an output tensor B that is smaller, in the X and/or Y direction, relative to an input tensor A. For example, FIG. 3 illustrates a 5×5 input tensor A (with one plane or channel) convolved with a 3×3 filter W with a stride size of 2 in the X and Y directions, which produce a 2×2 output tensor B. Specifically, the input tensor A has 5×5 input data elements, e.g., A_{1,1}, A_{1,2}, A_{1,3}, A_{1,4}, A_{1,5}, A_{2,1}, A_{2,2}, A_{2,3}, A_{2,4}, A_{2,5}, A_{3,1}, A_{3,2}, A_{3,3}, A_{3,4}, A_{3,5}, A_{4,1}, A_{4,2}, A_{4,3}, A_{4,4}, A_{4,5}, A_{5,1}, A_{5,2}, A_{5,3}, A_{5,4}, and A_{5,5}; and the filter W has 3×3 weight data elements, e.g., W_{1,1}, W_{1,2}, W_{1,3}, W_{2,1}, W_{2,2}, W₂₃, W_{3,1}, W_{3,2}, and W_{3,3}. Each output data element of the output tensor B, B_{i,j} (where “i” represents the row and “j” represents the column in the output tensor), is equal to the dot product of the input data elements and weight data elements when the first weight data element W_{1,1} is aligned with the input data element A_{2i-1,2j-1}.

For example, the output data element B_{1,1} is equal to the dot product of the input data elements and weight data elements when the weight data element W_{1,1} is aligned with the input data element A_{1,1} (as indicated by 301). Specifically, the output element B_{1,1} is equal to A_{1,1}×W_{1,1}+A_{1,2}×W_{1,2}+A_{1,3}×W_{1,3}+A_{2,1}×W_{2,1}+A_{2,2}×W_{2,2}+A_{2,3}×W_{2,3}+A_{3,1}×W_{3,1}+A_{3,2}×W_{3,2}+A_{3,3}×W_{3,3}. Given the stride size being 2, the window is next moved in the X-direction (e.g., to the right) with a step of 2 input data elements, causing the weight data element W_{1,1} to align with the input data element A_{1,3} (as indicated by 303). Consequently, the output data element B_{1,2} is equal to A_{1,3}×W_{1,1}+A_{1,4}×W_{1,2}+A_{1,5}×W_{1,3}+A_{2,3}×W_{2,1}+A_{2,4}×W_{2,2}+A_{2,5}×W_{2,3}+A_{3,3}×W_{3,1}+A_{3,4}×W_{3,2}+A_{3,5}×W_{3,3}. Following the same principle, the output data element B_{2,1} can be generated by moving the window in the X-direction (to the left) and the Y-direction (to the bottom) to align the weight data element W_{1,1} with the input data element A_{3,1}, and the output data element B_{2,2} can generated by moving the window in the X-direction (to the right) to align the weight data element W_{1,1} with the input data element A_{3,3}.

As mentioned above, various types of convolutional layers, e.g., a regular convolutional layer and a depth-wise convolutional layer, have been implemented in a neural network. Although the input tensor A is shown as having a single plane (or channel) in the example schematic diagram of FIG. 3, it should be understood that the described principle should be applied to both the regular convolutional layer and the depth-wise convolutional layer. For example, with the filter W implemented as a regular convolutional layer, when the input tensor A has multiple planes (or channels), the same filter W is convolved with all channels. In another example, with the filter W implemented as a depth-wise convolutional layer, when the input tensor A has multiple planes (or channels), the filter W is convolved with only one of the channels.

Other than the convolutional layer discussed above, the attention layer has been widely adapted in transformer-based models (e.g., large language models) for handling longer sequences or sentences. In general, an attention mechanism mimics cognitive attention by emphasizing the important parts of an input and deemphasizing the less important parts of the input. Attention mechanisms involve queries, values, and keys, where queries mimic volitional cues in cognitive attention, values (e.g., intermediate feature representations) mimic sensory inputs in cognitive attention, and keys mimic non-volitional cue of the sensory input in cognitive attention. Attention mechanisms map queries and sets of key-value pairs to corresponding outputs, where the query, keys, values, and output are all vectors; the output is computed as a weighted sum of the values, where the weight assigned to each value is computed by a compatibility function of the query with the corresponding key. In other words, each query attends to all the key-value pairs and generates one attention output.

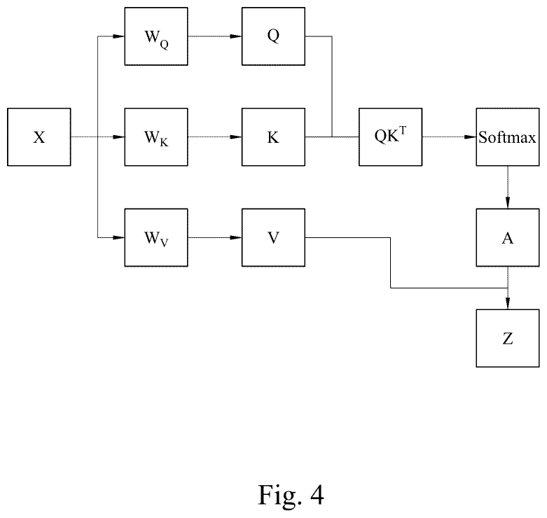

FIG. 4 illustrates an example schematic diagram of an input (tensor) “X” processed in an attention mechanism, in accordance with various embodiments. The schematic diagram of FIG. 4 outlines the flow chart of a self-attention mechanism. It should be noted that the schematic diagram of FIG. 4 is provided merely as a non-limiting example for illustrative purposes, and does not intend to limit the scope of the present disclosure. For example, the disclosed memory circuit (e.g., FIG. 5) can also be implemented to process any of various other attention layer types (e.g., cross-attention mechanism or multi-head attention), while within the scope of the present disclosure.

As shown, an attention mechanism generally includes a transformer (or transformer model) to define three learnable weight matrices to transform, including a query weight matrix W_{Q}, a key weight matrix W_{K}, and a value weight matrix W_{V}. In general, these three weight matrices operatively serve to project the input tensor X into query, key, and value components of the sequence, respectively. The input tensor X is first projected onto these weight matrices (e.g., by multiplying the input tensor X by each weight matrix), generating a query matrix Q (Q=X·W_{Q}), a key matrix K (K=X·W_{K}), and a vector matrix V (V=X·W_{V}). The transformer next computes the dot-product of the query with all keys as A=Q·K^{T}, where K^{T} represents the key matrix K being transposed. The matrix A is then normalized or scaled using a softmax operator to obtain attention scores A′, which are sometimes referred to as attention weights A′. An output Z can thus be generated as A′·V, where each entity of the output Z becomes the weighted sum of all entities in the input, with the weights given by the attention scores A′. In some embodiments, the transformer shown in FIG. 4 (e.g., the components W_{Q}, W_{K}, W_{V}, Q, K, V, Q·K^{T}, and A) may sometimes be referred to as an attention layer. In some other embodiments, an attention mechanism can include a plural number of the illustrated attention layers, and the plural attention layers are coupled to a fully connected layer that outputs (or flattens) previous outputs (Z) of the plural attention layers into a single vector. Such an attention mechanism allows the transformer to focus on relevant parts of the input tensor X based on similarity between the query matrix (or vector) Q and the key matrix (or vector) K, enhancing the corresponding model's ability to capture dependencies and relationships within data effectively.

FIG. 5 illustrates an example block diagram of a Compute-In-Memory (CIM) circuit 500, in accordance with various embodiments. It should be understood that the block diagram of FIG. 5 has been simplified, and thus, the CIM circuit 500 can include any of various other components while remaining within the scope of the present disclosure.

As shown, the CIM circuit 500 includes an array 510, a first buffer 520, a second buffer 530, a data router 540, a column-wise write circuit 550, a controller 560, and an adder peripheral circuit 570. In a brief overview, the CIM circuit 500, which may operatively serve as a part of an AI accelerator, can adaptively configure its components based on the layer type of a neural network for processing multiple input data elements and weight data elements, in the interest of high efficiency, low power consumption, and low latency.

The array 510 may comprise a number of processing elements (PEs) 512 arranged over a plurality of columns (C₁, C₂ . . . C_{Y}) and a plurality of rows (R₁, R₂ . . . R_{X}). Each of the PEs 512 is located at the intersection of a corresponding one of the columns and a corresponding one of the rows. Each of the PEs 512 may include at least a number of registers (or storage cells), e.g., M₀, M₁ . . . M_{N}, and a computation component CP (e.g., a multiplier). The storage cell can be a storage space for the unit of a memory that is configured to transfer data for immediate use by a Central Processing Unit (CPU) or Graphic Processing Unit (GPU) for data processing. In some embodiments, each PE 512 can include a plural number of such storage cells. The storage cells M₀ to M_{N} of each PE 512 can be configured to selectively store a singular one of a plurality of weight data elements or plural ones of a plurality of input data elements, which will be discussed below. The storage cells M₀ to M_{N} of each PE 512 may be arranged along a single column, with the storage cells disposed in respective rows. As such, such a PE is sometimes referred to as multi-row storage memory cell. The computation component CP can perform a multiplication operation on an activation with an output of the storage cells M₀ to M_{N}. Each of the PEs 512 (or its computation component CP) can be configured to perform a multiplication operation on a corresponding one of a plurality of first data elements (e.g., input activations or input data elements) and a corresponding one of a plurality of second data elements (e.g., weights or weight data elements), and then perform a summation operation to combine the one or more products so as to generate a partial product. Each PE may provide an output (e.g., a partial product) to the adder peripheral circuit 570 for summation operations. The adder peripheral circuit 570 can include a number of adder trees, a number of shifters, or other suitable circuits each configured to perform a summation operation, in some embodiments.

The first buffer 520 may include one or more memories (e.g., registers) that can receive and store input activations (or input data elements) for a neural network. The first buffer 520 may sometimes be referred to as activation buffer 520. These input data elements can be received as outputs from, e.g., a different memory circuit (not shown), a global buffer (not shown), or a different device. In some embodiments, the input data elements from the activation buffer 520 may be provided to the data router 540 for selectively storing in the PEs 512 based on a control signal 516 provided by the controller 560, which will be described in further detail below.

The second buffer 530 may include one or more memories (e.g., registers) that can receive and store weights (or weight data elements) for the neural network. The second buffer 530 may sometimes be referred to as weight buffer 530. These weight data elements can be received as outputs from, e.g., a different memory circuit (not shown), a global buffer (not shown), or a different device. In some embodiments, the weight data elements from the weight buffer 530 may be provided to the data router 540 for selectively storing in the PEs 512 based on the control signal 561 provided by the controller 560, which will be described in further detail below.

The data router 540, operatively coupled to the activation buffer 520 and the weight buffer 530, can select the data elements to be stored in the PEs 512 based on the control signal 561 provided by the controller 560. For example, the array 510 can further include at least one write port 514 and one input port 516. In various embodiments of the present disclosure, the write port 514 is configured to receive data elements to be programmed into the PEs 512; and the input port 516 is configured to receive data elements to be multiplied by the data elements stored in the PEs. The control signal 561 can indicate a layer type of the neural network for processing the input data elements and the weight data elements. For example, the layer type may include at least a regular convolutional layer, an attention layer, and a depth-wise convolutional layer.

In one aspect, based on the control signal 561 indicating that the data elements to be processed is associated with a regular convolutional layer (mechanism) or an attention layer (mechanism), the data router 540 can select the input data elements received from activation buffer 520 and forward them to the input port 516, and select the weight data elements received from the weight buffer 530 and forward them to the write port 514. As such, the weight data elements are stored in the PEs 512, with the input data elements multiplied by the corresponding stored weight data elements, which is sometimes referred to as “weight stationary (WS) dataflow.” Further, each PE 512 may utilize a singular one of its storage cells to store a corresponding one of the weight data elements, in some embodiments.

In another aspect, based on the control signal 561 indicating that the data elements to be processed is associated with a depth-wise convolutional layer (mechanism), the data router 540 can select the input data elements received from activation buffer 520 and forward them to the write port 514, and select the weight data elements received from the weight buffer 530 and forward them to the input port 516. As such, the input data elements are stored in the PEs 512, with the weight data elements multiplied by the corresponding stored input data elements, which is sometimes referred to as “input stationary (IS) dataflow.” Further, each PE 512 may utilize multiple ones of its storage cells to store corresponding ones of the input data elements, respectively, in some embodiments.

The controller 560 can generate the control signal 561 by identifying the layer type of the neural network. In some embodiments, the controller 560 can be communicatively coupled with another component (e.g., a user interface) indicating the layer type. In addition to generating the control signal 561 for the data router 540 to select which of the data elements to be programmed into the PEs 512 of the array 510, the controller 560 can generate another control signal 563 to selectively configure the column-wise write circuit 550.

For example, when the layer type is identified as including an attention layer, the controller 560 can generate the control signal 563 to switch between a first logic state to cause the column-wise write circuit 550 to enable column-wise write back operation and a second logic state to cause the column-wise write circuit 550 to disable column-wise write back operation. When the layer type is identified as including a convolutional layer (e.g., a regular or depth-wise convolutional layer), the controller 560 can generate the control signal 563 fixe at the second logic state, causing the column-wise write circuit 550 to disable the column-wise write back operation. When the column-wise write back operation is disabled, the column-wise write circuit 550 may perform a row-wise write operation. With the column-wise write back operation, the CIM circuit 500 is free from including additional circuit to perform a transpose function that is typically required in processing a neural network with an attention layer. Such a column-wise write back operation will be discussed in further detail below.

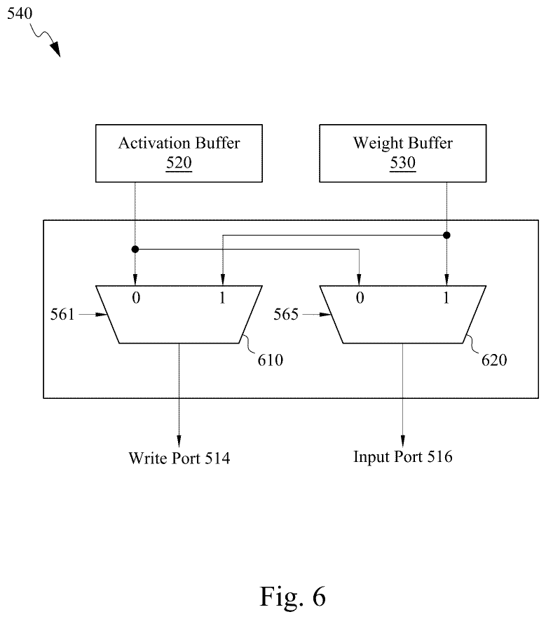

FIG. 6 illustrates an example circuit diagram of the data router 540, in accordance with various embodiments. The data router 540 is operatively coupled between the buffers 520-530 and the ports 514-516, and is configured to select the data elements to be forwarded to the write port 514 based on the control signal 561. It should be understood that the circuit diagram of FIG. 6 has been simplified, and thus, the data router 540 can include any of various other components while remaining within the scope of the present disclosure.

As shown, the data router 540 includes a first multiplexer (MUX) 610 and a second multiplexer (MUX) 620. In the illustrative example of FIG. 6, each of the first MUX 610 and the second MUX 620 is implemented as a 2-to-1 MUX controlled by a respective control signal. For example, the first MUX 610 is controlled by the control signal 561, and the second MUX 620 is controlled by another control signal 565 that is logically inverse to the control signal 561. Further, the first MUX 610 has a first input and a second input configured to receive an input data element and a weight data element from the activation buffer 520 and the weight buffer 530, respectively, and the second MUX 620 has a first input and a second input configured to receive an input data element and a weight data element from the activation buffer 520 and the weight buffer 530, respectively. Based on a logic state of the control signal 561, the first MUX 610 can select one of the data elements received through its first or second input as an output forwarded to the write port 514. Similarly, the second MUX 620 can select one of the data elements received through its first or second input as an output forwarded to the input port 516, based on a logic state of the control signal 565.

As the control signals 561 and 565 are logically inverse to each other, the data router 540 can determine based on the control signal 561 whether to route the input data elements or the weight data elements to the write port 514. For example, when the control signal 561 is at a first logic state indicative of the layer type being a regular convolutional layer or attention layer, the first MUX 610 can select the data element received from its second input (e.g., a weight data element) and forward it to the write port 514. Concurrently, the second MUX 620 can select the data element received from its first input (e.g., an input data element) and forward it to the input port 516. When the control signal 561 is at a second logic state indicative of the layer type being a depth-wise convolutional layer, the first MUX 610 can select the data element received from its first input (e.g., an input data element) and forward it to the write port 514. Concurrently, the second MUX 620 can select the data element received from its second input (e.g., a weight data element) and forward it to the input port 516.

According to various embodiments of the present disclosure, when the layer type is indicated as a regular convolutional layer or attention layer (i.e., the write port 514 receiving the weight data element and the input port 516 receiving the input data element), the data router 540 may output a singular one of the weight data elements into a corresponding one of the PEs 512; and when the layer type is indicated as a depth-wise convolutional layer (i.e., the write port 514 receiving the input data element and the input port 516 receiving the weight data element), the data router 540 may output multiple ones of the weight data elements into a corresponding one of the PEs 512. Further,

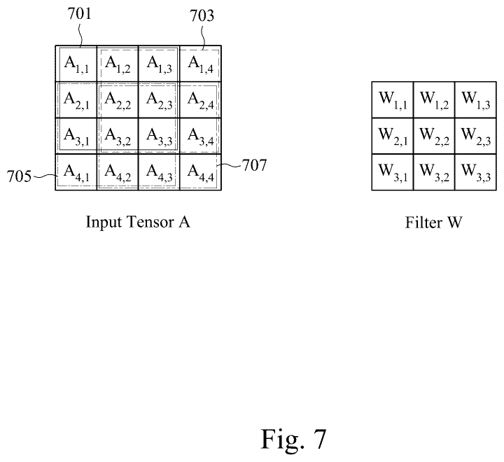

FIG. 7 illustrates another example block diagram of an input tensor “A” processed in a convolution mechanism with a filter/weight “W,” where the input tensor A has a dimension of 4×4 and the filter W has a dimension of 3×3, with a stride size of 1. For example in FIG. 7, the input tensor A has input data elements, A_{1,1}, A_{1,2}, A_{1,3}, A_{1,4}, A_{2,1}, A_{2,2}, A_{2,3}, A_{2,4}, A_{3,1}, A_{3,2}, A_{3,3}, A_{3,4}, A_{4,1}, A_{4,2}, A_{4,3}, and A_{4,4}, arranged over 4 columns and 4 rows; and the filer W has weight data elements, W_{1,1}, W_{1,2}, W_{1,3}, W_{2,1}, W_{2,2}, W_{2,3}, W_{3,1}, W_{3,2}, and W_{3,3}, arranged over 3 columns and 3 rows.

Based on the convolutional principle discussed with respect to FIGS. 2-3, a first convolutional window (in a dimension of 3×3) is generated to align the weight data element W_{1,1} with the input data element A_{1,1}, with the remaining weight data element W_{1,2} W_{1,3}, W_{2,1}, W_{2,2}, W_{2,3}, W_{3,1}, W_{3,2}, and W_{3,3} aligned with the input data elements A_{1,2}, A_{1,3}, A_{2,1}, A_{2,2}, A_{2,3}, A_{3,1}, A_{3,2}, and A_{3,3}, respectively. As a result, a first partial product can be generated by a corresponding PE (e.g., 512) through multiplying the input data elements with the respective aligned weight data elements (i.e., A_{1,1}×W_{1,1}+A_{1,2}×W_{1,2}+A_{1,3}×W_{1,3}+A_{2,1}×W_{2,1}+A_{2,2}×W_{2,2}+A_{2,3}×W_{2,3}+A_{3,1}×W_{3,1}+A_{3,2}×W_{3,2}+A_{3,3}×W_{3,3}). Such a first convolutional window is indicated by 701. Next, second, third, and fourth convolutional windows (in the same dimension of 3×3) are generated to align the weight data element W_{1,1} with the input data elements A_{1,2}, A_{2,1}, and A_{2,2}, as indicated by 703, 705, and 707, respectively.

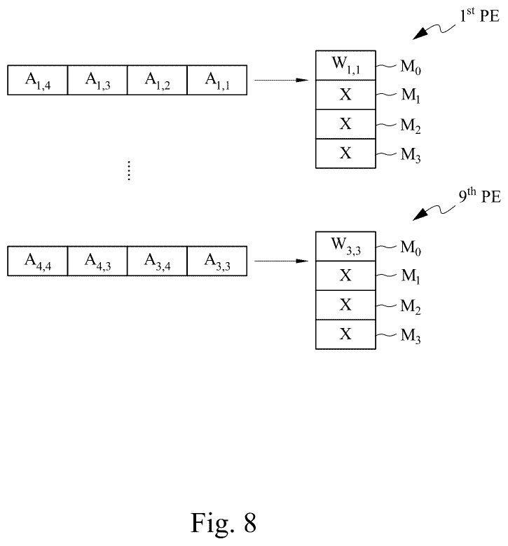

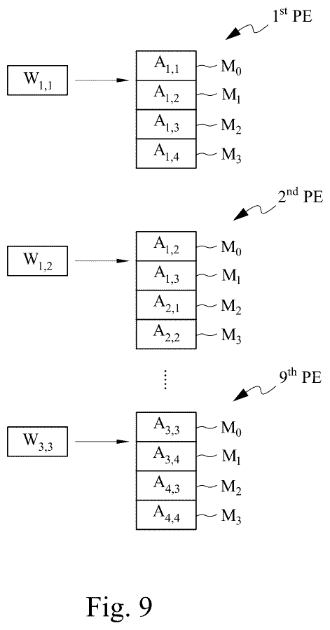

Using the input tensor A and filter W of FIG. 7 as an illustrative example, FIG. 8 and FIG. 9 respectively illustrate schematic diagrams of how the data elements are stored in the PEs 512 when the layer type is indicated as a regular convolutional layer (or attention layer) and a depth-wise convolutional layer, in accordance with various embodiments. In particular, FIG. 8 illustrates an example of generating partial products based on the weight stationary (WS) dataflow, and FIG. 9 illustrates an example of generating partial products based on the input stationary (IS) dataflow.

In FIG. 8, the weight data element W_{1,1} is routed by the data router 540 to the write port 514 of the array 510 and then stored in a first one of the PEs 512 of the array 510, where each of the PEs 512 may have 4 rows of storage cells, M₀, M₁, M₂, and M₃. The weight data element W_{1,1} may be stored in the storage cell M₀ of the first PE 512. Corresponding input data elements A_{1,4}, A_{1,3}, A_{1,2}, A_{1,1} are routed by the data router 540 to the input port 516 as an activation of the first PE 512. In some embodiments, the activation of the first PE 512 (e.g., the input data elements A_{1,4}, A_{1,3}, A_{1,2}, A_{1,1}) may be fed into the array 510 on a row basis. Further, the input data elements A_{1,4}, A_{1,3}, A_{1,2}, A_{1,1} are the data elements in the windows 701 to 707, respectively, that are to be multiplied (aligned) with the weight data element W_{1,1}. Following the same principle, the weight data elements W_{1,2} W_{1,3}, W_{2,1}, W_{2,2}, W_{2,3}, W_{3,1}, W_{3,2}, and W_{3,3} are each stored in one of the storage cells of a corresponding one of second, third, fourth, fifth, sixth, seventh, eighth, and ninth PEs, with the corresponding activation (input data elements) fed into the array 510. In some embodiments, these nine PEs may be arranged along a single column of the array 510, while other configuration can be contemplated.

In FIG. 9, the input data elements A_{1,4}, A_{1,3}, A_{1,2}, A_{1,1} are routed by the data router 540 to the write port 514 of the array 510 and then stored in a first one of the PEs 512 of the array 510. Specifically, the PEs 512 may store the input data elements A_{1,1}, A_{1,2}, A_{1,3}, and A_{1,4} in the storage cells, M₀, M₁, M₂, and M₃, respectively. In some embodiments, the input data elements A_{1,4}, A_{1,3}, A_{1,2}, A_{1,1} may be fed into the array 510 on a column basis. Further, the input data elements A_{1,4}, A_{1,3}, A_{1,2}, A_{1,1} are the data elements in the windows 701 to 707, respectively, that are to be multiplied (aligned) with the weight data element W_{1,1}. The corresponding weight data element W_{1,1} is routed by the data router 540 to the input port 516 as an activation of the first PE 512. Following the same principle, respective sets of the input data elements, (A_{1,2}, A_{1,3}, A_{2,2}, and A_{2,3}), (A_{1,3}, A_{1,4}, A_{2,3}, and A_{2,4}), (A_{2,1}, A_{2,2}, A_{3,1}, and A_{3,2}), (A_{2,2}, A_{2,3}, A_{3,2}, and A_{3,3}), (A_{2,3}, A_{2,4}, A_{3,3}, and A_{3,4}), (A_{3,1}, A_{3,2}, A_{4,1}, and A_{4,2}), (A_{3,2}, A_{3,3}, A_{4,2}, and A_{4,3}), (A_{3,3}, A_{3,4}, A_{4,3}, and A_{4,4}), corresponding to the weight data elements W_{1,2} W_{1,3}, W_{2,1}, W_{2,2}, W_{2,3}, W_{3,1}, W_{3,2}, and W_{3,3}, respectively, are each stored in the storage cells of a corresponding one of second, third, fourth, fifth, sixth, seventh, eighth, and ninth PEs, with the corresponding activation (weight data elements) fed into the array 510. In some embodiments, these nine PEs may be arranged along a single column of the array 510, while other configuration can be contemplated.

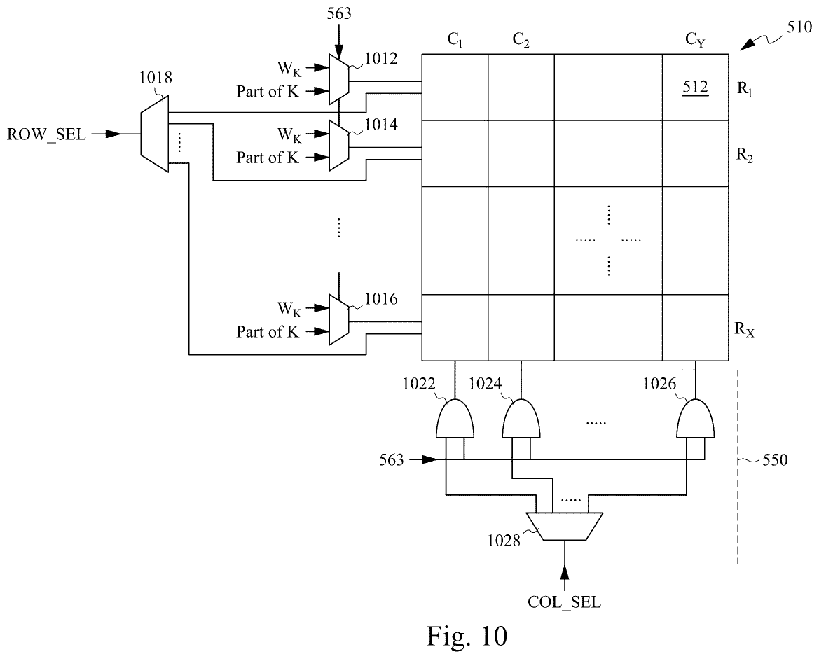

FIG. 10 illustrates an example circuit diagram of the column-wise write circuit 550, in accordance with various embodiments. The column-wise write circuit 550 is operatively coupled between the data router 540 and the write port 514, and is configured to selectively perform a column-wise write back operation based on the control signal 563. It should be understood that the circuit diagram of FIG. 10 has been simplified, and thus, the column-wise write circuit 550 can include any of various other components while remaining within the scope of the present disclosure.

As shown, the column-wise write circuit 550 is coupled to the array 510 through its write port 514 (not shown in FIG. 10). The array 510 is shown as having “Y” columns and “X” rows of PEs 512, where X and Y may be each an integer equal to or greater than 2. In some embodiments, the column-wise write circuit 550 may include a number of MUX'es 1012, 1014, 1016, etc., coupled to the rows of the array 510, respectively, and a number of AND gates 1022, 1024, 1026, etc., coupled to the columns of the array 510, respectively. The rows of the array 510 may be coupled to a MUX 1018 configured to select one of the rows based on a “ROW_SEL” signal, and the columns of the array 510 may be coupled to a MUX 1028 configured to select one of the columns based on a “COL_SEL” signal.

To selectively enable the column-wise write back operation mentioned above, the MUX'es 1012 to 1016 are each controlled by the control signal 563. The control signal 563 is sometimes referred to as a “COL_EN” signal, which is somehow indicative of whether the layer type of a corresponding neural network contains an attention layer or the like that requires a transpose function. For example, the control signal 563 may transition between a first logic state and a second logic state to selectively enable the column-wise write back operation, when processing an attention-related mechanism. In another example, when the layer type of the neural network is not associated with any attention-related mechanism or requires no transpose function, the control signal 563 may be held at a constant logic state to disable the column-wise write back operation.

Specifically, each of the MUX'es 1012 to 1016 can have a first input, a second input, and an output. Each of the first and second inputs is configured to receive a number of data elements through the write port 514 (FIG. 5). That is, the data elements received through either the first or second input are configured to be programmed into the array 510 (or the PEs 512). In various embodiments, the first input is configured to receive a number of data elements (e.g., weight data elements of the key weight matrix W_{K} illustrated in FIG. 4) through the write port 514 and the second input is configured to receive a portion of the data elements that have been multiplied with the corresponding activation (e.g., one of the data elements of the key matrix K illustrated in FIG. 4) also through the write port 514. Upon the control signal 563 indicating that the column-wise write back operation is enabled, the MUX'es 1012 to 1016 may each select the data elements received from the second input and forward them to its output; and upon the control signal 563 indicating that the column-wise write back operation is disabled, the MUX'es 1012 to 1016 may each select the data elements received from the first input and forward them to its output.

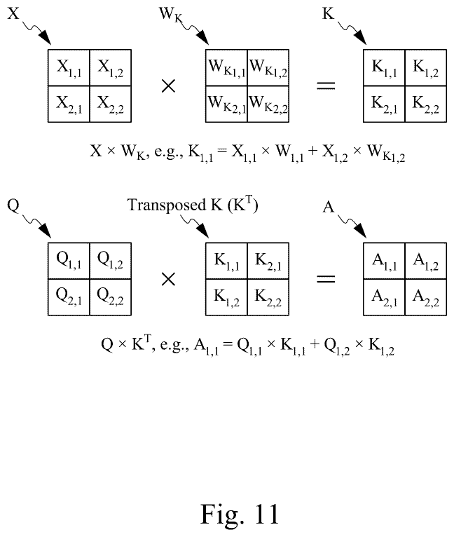

FIG. 11 illustrates an example block diagram of a portion of an attention mechanism, in which an input tensor “X” is processed with a key weight matrix “W_{K}” to generate a matrix “K,” and a query matrix “Q” is processed with the matrix K^{T} being transposed to generate a pre-normalized weight score matrix “A,” in accordance with various embodiments. It should be understood that the example of FIG. 11 has been simplified for illustrative purposes, and the dimension of each of the matrix can be equal to any other value.

In the illustrative example of FIG. 11, the input tensor X, the key weight matrix W_{K}, and the query matrix Q each have a dimension of 2×2. The input tensor X has input data elements, X_{1,1}, X_{1,2}, X_{2,1}, and X_{2,2}, arranged over 2 columns and 2 rows; the key weight matrix W_{K} has weight data elements, W_{K1,1}, W_{K1,2}, W_{K2,1}, and W_{K2,2}, arranged over 2 columns and 2 rows; and the query matrix Q has weight data elements, Q_{1,1}, Q_{1,2}, Q_{2,1}, and Q_{2,2}, arranged over 2 columns and 2 rows. Based on the attention mechanism discussed above (e.g., FIG. 4), the matrix K, consisting of K_{1,1}, K_{1,2}, K_{2,1}, and K_{2,2} arranged over 2 columns and 2 rows, is generated by multiplying the input tensor X with the key weight matrix W_{K} (K=X·W_{K}). Next, the matrix A, consisting of A_{1,1}, A_{1,2}, A_{2,1}, and A_{2,2} arranged over 2 columns and 2 rows, is generated by multiplying the query matrix Q with the transposed matrix K^{T} (A=Q·K^{T}).

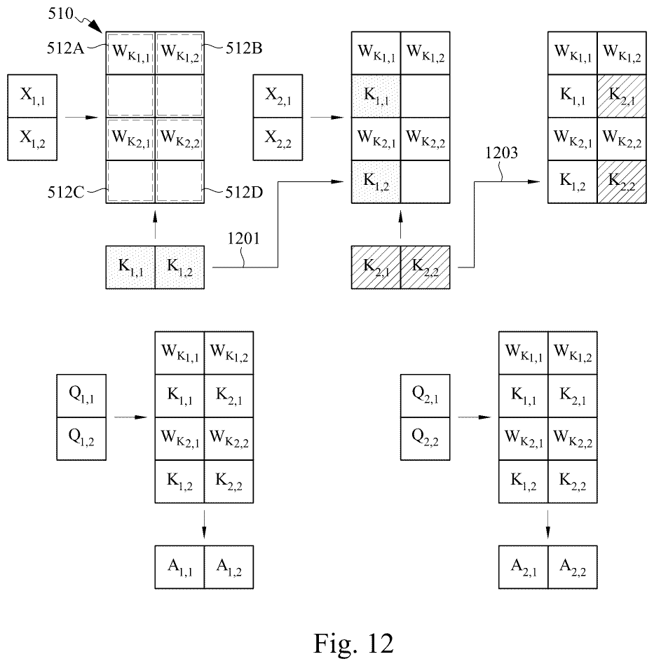

FIG. 12 is an operation flow illustrating how the column-wise write circuit 550 processes the input tensor X, key weight matrix W_{K}, and query matrix Q shown in FIG. 11 to read out intermediate results from the array 510 while simultaneously performing the column-wise write back operation, in accordance with various embodiments. For example in FIG. 12, the array 510 is shown as having four PEs, 512A, 512B, 512C, and 512D, arranged as a 2×2 array, and each of the PEs 512A to 512D includes two storage cells.

First, the data elements of the key weight matrix W_{K}, W_{K1,1}, W_{K1,2}, W_{K2,1}, W_{K2,2}, are programmed into the four PEs 512, respectively. Specifically, the first row of the key weight matrix W_{K} (W_{K1,1} and W_{K1,2}) are wrote into the first storage cells of the first row of PEs 512A and 512B, respectively, and the second row of the key weight matrix W_{K} (W_{K2,1} and W_{K2,2}) are wrote into the first storage cells of the second row of PEs 512C and 512D, respectively. Stated another way, the data elements of the key weight matrix W_{K} are written into the array 510 row-wise. The first row of the input tensor X (X_{1,1} and X_{1,2}), which may be received through the input port 516, are multiplied with the first column of the data elements stored in the first storage cells (W_{K1,1} and W_{K2,1}) and multiplied with the second column of the data elements stored in the first storage cells (W_{K1,2} and W_{K2,2}) to generate intermediate results, e.g., data elements K_{1,1} and K_{1,2}, respectively. For example, K_{1,1}=X_{1,1}×W_{K1,1}+X_{1,2}×W_{K2,1}, and K_{1,2}=X_{1,1}×W_{K1,2}+X_{1,2}×W_{K2,2}.

Concurrently with the data elements K_{1,1} and K_{1,2} being generated or read out, the column-wise write circuit 550 can write back those data elements (intermediate results) into the array 510 column-wise, as indicated by arrow 1201. For example, the data element K_{1,1} is written into the second storage cell of the first one of the first column of PEs (e.g., 512A) and the data element K_{1,2} is written into the second storage cell of the second one of the same first column of PEs (e.g., 512C). Next, the second row of the input tensor X (X_{2,1} and X_{2,2}), which may be received through the input port 516, are multiplied with the first column of the data elements stored in the first storage cells (W_{K1,1} and W_{K2,1}) and multiplied with the second column of the data elements stored in the first storage cells (W_{K1,2} and W_{K2,2}) to generate intermediate results, e.g., data elements K_{2,1} and K_{2,2}, respectively. Similarly, the column-wise write circuit 550 can write back those data elements K_{2,1} and K_{2,2} into the array 510 column-wise, as indicated by arrow 1203. For example, the data element K_{2,1} is written into the second storage cell of the first one of the second column of PEs (e.g., 512B) and the data element K_{2,2} is written into the second storage cell of the second one of the same second column of PEs (e.g., 512D).

With the data elements K_{1,1}, K_{1,2}, K_{2,1}, and K_{2,2} written back in the array 510 column-by-column, the data elements K_{1,1}, K_{1,2}, K_{2,1}, and K_{2,2} are equivalently transposed in the array 510. For example, the data element K_{1,2} has been changed from a first position at the intersection of a first row and a second column (of the key matrix K in FIG. 11) to a second position at the intersection of a second row and a first column (of the matrix formed by the PEs 512A to 512D), similar for the data element K_{2,1}. As such, the first row of the query matrix Q (Q_{1,1} and Q_{1,2}), which may be received through the input port 516, can be multiplied with the first column of the data elements stored in the second storage cells (K_{1,1} and K_{1,2}) and multiplied with the second column of the stored data elements stored in the second storage cells (K_{2,1} and K_{2,2}) to generate the data elements A_{1,1} and A_{1,2}, respectively. For example, A_{1,1}=Q_{1,1}×K_{1,1}+Q_{1,2}×K_{1,2}, and A_{1,2}=Q_{1,1}×K_{2,1}+Q_{1,2}×K_{2,2}. Similarly, the data elements A_{2,1} and A_{2,2}, can be generated through multiplying the second row of the query matrix Q (Q_{2,1} and Q_{2,2}) with the data elements (K_{1,1} and K_{1,2}) and with the data elements (K_{2,1} and K_{2,2}), respectively.

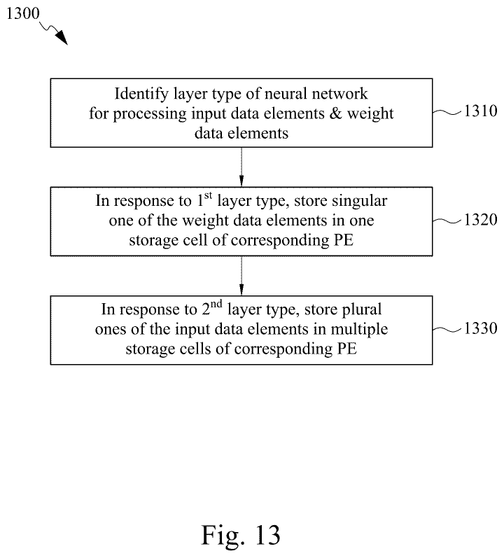

FIG. 13 illustrates a flow chart of an example method 1300 for operating a CIM circuit, in accordance with various embodiments of the present disclosure. The operations of the method 1300 may be performed by the components described above (e.g., FIGS. 5 and 6), and thus, some of the reference numerals used above may be re-used the following discussion of the method 1300. For example, the method 1300 is mostly directed to the operations performed by the controller 560 and data router 540. It is understood that the method 1300 has been simplified, and thus, additional operations may be provided before, during, and after the method 1300 of FIG. 13, and that some other operations may only be briefly described herein.

The method 1300 starts with operation 1310 of identifying the layer type of a neural network for processing a plurality of input data elements and a plurality of weight data elements. For example, the controller 560 can identify such a layer type, and provide the control signal 561 to the data router 540. As a non-limiting example, the control signal 561 may be provided at a first logic state when the layer type (a first type) is a regular convolutional layer or an attention layer, and at a second logic state when the layer type (a second type) is a depth-wise convolutional layer. It should be any of the first or second logic state can be indicative of any of various other layer types of a neural network, while remaining within the scope of the present disclosure.

The method 1300 proceeds with operation 1320 of storing a singular one of the weight data elements in one storage cell of a corresponding processing element (PE), responsive to the first type being identified. Continuing with the same example, in response to the control signal 561 being provided at the first logic state (e.g., a regular convolutional layer or an attention layer), the data router 540 (or its first MUX 610 in the non-limiting implementation of FIG. 6) can select the weight data element(s) received from the weight buffer 530 to be forwarded to the write port 514 of the array 510. Concurrently, the data router 540 (or its second MUX 620) can select the input data element(s) received from the activation buffer 520 to be forwarded to the input port 516 of the array 510. The weight data elements received through the write port 514 can be programmed into different PEs, respectively. Specifically, each PE, with a plural number of storage cells, can store the corresponding weight data element in one of its multiple storage cells. The stored weight data element can be multiplied with a subset of the input data elements (e.g., plural ones of the input data elements) which may be fed into the array 510 row-wise, in some embodiments.

The method 1300 proceeds with operation 1330 of storing plural ones of the input data elements in multiple storage cells of the corresponding processing element (PE), responsive to the second type being identified. Continuing with the same example, in response to the control signal 561 being provided at the second logic state (e.g., a depth-wise convolutional layer), the data router 540 (or its first MUX 610 in the non-limiting implementation of FIG. 6) can select the input data element(s) received from the activation buffer 520 to be forwarded to the write port 514 of the array 510. Concurrently, the data router 540 (or its second MUX 620) can select the weight data element(s) received from the weight buffer 530 to be forwarded to the input port 516 of the array 510. The input data elements received through the write port 514 can be programmed into different PEs, respectively. Specifically, each PE, with a plural number of storage cells, can store corresponding input data elements in its multiple storage cells, respectively. The stored input data elements can be multiplied with a subset of the weight data elements (e.g., a singular one of the weight data elements) which may be fed into the array 510 row-wise, in some embodiments.

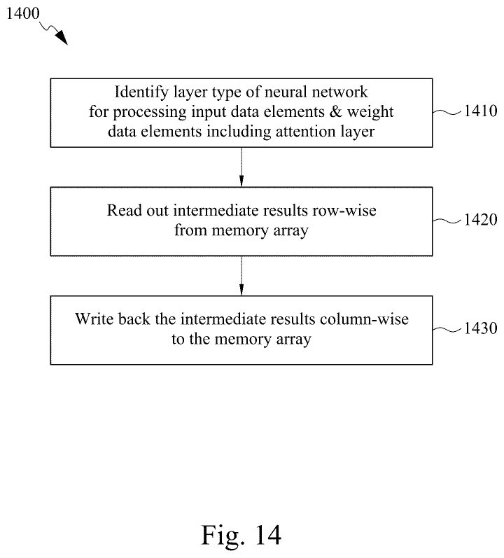

FIG. 14 illustrates a flow chart of an example method 1400 for operating a CIM circuit, in accordance with various embodiments of the present disclosure. The operations of the method 1400 may be performed by the components described above (e.g., FIGS. 5 and 10), and thus, some of the reference numerals used above may be re-used the following discussion of the method 1400. For example, the method 1400 is mostly directed to the operations performed by the controller 560 and column-wise write circuit 550. It is understood that the method 1400 has been simplified, and thus, additional operations may be provided before, during, and after the method 1400 of FIG. 14, and that some other operations may only be briefly described herein. For example, the method 1400 can be selectively performed after the method 1300.

The method 1400 starts with operation 1410 of identifying that the layer type of a neural network for processing a plurality of input data elements and a plurality of weight data elements includes an attention layer. In some embodiments, operation 1410 may be identical to or a part of operation 1310 of the method 1300. For example, the controller 560 can identify the attention layer, and provide the control signals 561 and 563 to the data router 540 and the column-wise write circuit 550, respectively. The control signal 563 may be provided as switching between a first logic state and a second logic state when the layer type includes an attention layer, and as fixed at the second logic state when the layer type includes no attention layer.

The method 1400 continues to operation 1420 of reading out intermediate results from a memory array row-wise. Using FIG. 12 as a representative example, such intermediate results correspond to the data elements of matrix K (e.g., K_{1,1} and K_{1,2}) generated by multiplying a first row of the input tensor X (e.g., X_{1,1} and X_{1,2}) with the key weight matrix W_{K} (e.g., W_{K1,1}, W_{K1,2}, W_{K2,1}, and W_{K2,2}). For example, prior to reading out the data elements of matrix K, the column-wise write circuit 550 can write the data elements of the key weight matrix (W_{K1,1}, W_{K1,2}, W_{K2,1}, and W_{K2,2}) to the memory array 510 row-by-row, in response to the control signal 563 being provided at the second logic state. The first row of the key weight matrix W_{K} (W_{K1,1}, W_{K1,2}) can be stored in the respective first storage cells of the first row of PEs (512A and 512B), and the second row of the key weight matrix W_{K} (W_{K2,1}, W_{K2,2}) can be stored in the respective first storage cells of the second row of PEs (512C and 512D). Next, the data elements K_{1,1} and K_{1,2} can be generated by the PEs 512A-D based on K_{1,1}=X_{1,1}×W_{K1,1}+X_{1,2}×W_{K2,1} and K_{1,2}=X_{1,1}×W_{K1,2}+X_{1,2}×W_{K2,2}, respectively, and received by the column-wise write circuit 550 through the adder peripheral circuit 570.

The method 1400 continues to operation 1430 of writing back the intermediate results to the memory array column-wise. With the same example of FIG. 12, concurrently with the column-wise write circuit 550 receiving the data elements K_{1,1} and K_{1,2}, the column-wise write circuit 550 can then write back the data elements into the array 510 column-wise, in response to the control signal 563 transitioning to the first logic state. For example, the data elements K_{1,1} and K_{1,2} can be written back into the respective second storage cells of the first column of the PEs (512A and 512C). In various embodiments, operations 1420 and 1430 can be performed one or more times, causing the second row of the input tensor X (e.g., X_{2,1} and X_{2,2}) to be multiplied with the key weight matrix W_{K} as intermediate results (K_{2,1} and K_{2,2}) which are written back to the respective second storage cells of the second column of the PEs (512B and 512D).

In one aspect of the present disclosure, a memory circuit is disclosed. The memory circuit includes a first buffer configured to store a plurality of first data elements; a second buffer configured to store a plurality of second data elements; a controller configured to generate a control signal based on a layer type; an array comprising a plurality of processing elements (PEs), each of the PEs including a plurality of storage cells; and a data router configured to receive the control signal and determine whether to store, in the storage cells of each of the PEs, a corresponding one of the plurality of first data elements or corresponding ones of the plurality of second data elements based on the control signal.

In another aspect of the present disclosure, a memory circuit is disclosed. The memory circuit includes an array comprising a plurality of processing elements (PEs). Each of the PEs includes a plurality of storage cells. Each of the PEs is configured to selectively store, based on a control signal indicating a layer type, (i) a singular one of a plurality of first data elements in one of the corresponding storage cells; or (ii) plural ones of a plurality of second data elements in the corresponding storage cells, respectively.

In yet another aspect of the present disclosure, a method for operating a Compute-In-Memory circuit is disclosed. The method includes identifying a layer type of a neural network for processing a plurality of input data elements and a plurality of weight data elements. The method includes, in response to the layer type being a first type, storing a singular one of the plurality of weight data elements in one of a plurality of storage cells of a corresponding processing element. The method includes, in response to the layer type being a second type, storing plural ones of the plurality of input data elements in the plurality of storage cells of the corresponding processing element, respectively.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., +10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A memory circuit, comprising:
a first buffer configured to store a plurality of first data elements;
a second buffer configured to store a plurality of second data elements;
a controller configured to generate a control signal based on a layer type;
an array comprising a plurality of processing elements (PEs), each of the PEs including a plurality of storage cells; and
a data router configured to receive the control signal and determine whether to store, in the storage cells of each of the PEs, a corresponding one of the plurality of first data elements or corresponding ones of the plurality of second data elements based on the control signal.

2. The memory circuit of claim 1, wherein the first data elements include weight data elements, and the second data elements include input data elements.

3. The memory circuit of claim 1, wherein the data router includes:
a first multiplexer having a first input connected to the second buffer, a second input connected to the first buffer, and a first output connected to an input port of the array; and
a second multiplexer having a third input connected to the second buffer, a fourth input connected to the first buffer, and a second output connected to a write port of the array.

4. The memory circuit of claim 3, wherein the first multiplexer is configured to select a data element received from one of the first input or the second input based on a logically inverted version of the control signal, and the second multiplexer is configured to select a data element received from one of the third input or the fourth input based on the control signal.

5. The memory circuit of claim 4, wherein when the control signal indicates that the layer type is a regular convolutional layer or an attention layer, the first multiplexer is configured to output the second data elements to the input port and the second multiplexer is configured to output the first data elements to the write port.

6. The memory circuit of claim 5, wherein, in response to the indication of the control signal, each of the PEs is configured to store a single corresponding one of the first data elements.

7. The memory circuit of claim 4, wherein when the control signal indicates that the layer type is a depth-wise convolutional layer, the first multiplexer is configured to output the first data elements to the input port and the second multiplexer is configured to output the second data elements to the write port.

8. The memory circuit of claim 7, wherein, in response to the indication of the control signal, each of the PEs is configured to store plural corresponding ones of the second data elements.

9. The memory circuit of claim 8, wherein a number of the plural second data elements stored in each PE is determined based on at least one of: an arrangement of the first data elements which corresponds to a window size; an arrangement of the second data elements; or a stride size.

10. The memory circuit of claim 8, wherein the plural second data elements are stored along a single column of storage cells in each PE.

11. The memory circuit of claim 1, wherein the PEs are each configured to perform at least one multiplication operation on one or more of the plurality of first data elements and one or more of the plurality of second data elements.

12. A memory circuit, comprising:
an array comprising a plurality of processing elements (PEs);
wherein each of the PEs includes a plurality of storage cells; and
wherein each of the PEs is configured to selectively store, based on a control signal indicating a layer type, (i) a singular one of a plurality of first data elements in one of the corresponding storage cells; or (ii) plural ones of a plurality of second data elements in the corresponding storage cells, respectively.

13. The memory circuit of claim 12, wherein the first data elements include weight data elements, and the second data elements include input data elements.

14. The memory circuit of claim 12, further comprising a data router configured to receive the control signal and determine whether to store the singular one of the plurality of first data elements or the plural ones of the plurality of second data elements based on the control signal.

15. The memory circuit of claim 14, wherein the data router includes:
a first multiplexer having a first input configured to receive at least one of the second data elements, a second input configured to receive at least one of the first data elements, and a first output connected to an input port of the array; and
a second multiplexer having a third input configured to receive at least one of the second data elements, a fourth input configured to receive at least one of the first data elements, and a second output connected to a write port of the array.

16. The memory circuit of claim 15, wherein when the control signal indicates that the layer type is a regular convolutional layer or an attention layer, the first multiplexer is configured to output the at least one second data element received through the first input to the input port and the second multiplexer is configured to output the at least one first data element received through the fourth input to the write port.

17. The memory circuit of claim 15, wherein when the control signal indicates that the layer type is a depth-wise convolutional layer, the first multiplexer is configured to output the at least one first data element received through the second input to the input port and the second multiplexer is configured to output the at least one second data element received through the third input to the write port.

18. The memory circuit of claim 12, wherein the PEs are each configured to perform at least a multiplication operation on one or more of the plurality of first data elements and one or more of the plurality of second data elements.

19. A method, comprising:
identifying a layer type of a neural network for processing a plurality of input data elements and a plurality of weight data elements;
in response to the layer type being a first type, storing a singular one of the plurality of weight data elements in one of a plurality of storage cells of a corresponding processing element; and
in response to the layer type being a second type, storing plural ones of the plurality of input data elements in the plurality of storage cells of the corresponding processing element, respectively.

20. The method of claim 19, wherein the first type includes a regular convolutional layer or an attention layer, and the second type includes a depth-wise convolutional layer.
